(19) United States
(12) Patent Application Publication
(10) Pub. No.: US 2026/0367275 A1
(43) Pub. Date: Nov. 19, 2026

(54) METHOD AND RELATED APPARATUSES FOR IDENTIFYING AND CLASSIFYING A MAGNETIC ANOMALY

(71) Applicant: FNV IP B.V., Leidschendam (NL)

(72) Inventor: Victor SAVENIJE, Leidschendam (NL)

(73) Assignee: FNV IP B.V., Leidschendam (NL)

(21) Appl. No.: 19/136,720

(22) PCT Filed: Dec. 19, 2023
(86) PCT No.: PCT/EP2023/086534

§ 371 Date: Jun. 6, 2025

(30) Foreign Application Priority Data
Dec. 22, 2022 (NL) 2033803

(51) Int. Cl. G01V 3/08; G01V 3/38

(52) U.S. Cl. CPC G01V 3/081; G01V 3/38

(57) ABSTRACT

The disclosure provides a computer-implemented method for identifying and classifying a magnetic anomaly. The method comprises receiving data indicative of the magnetic profile of at least a portion of a target area; identifying a first extremum in the received data, wherein the first extremum is representative of a magnetic anomaly in the target area; identifying a second extremum in the received data, wherein the second extremum is representative of the same magnetic anomaly or a further magnetic anomaly in the target area and has an opposite polarity to the first extremum; and classifying the first extremum as a monopole or the first and second extrema as belonging to a first dipole. Associated systems are also described. Unlocking insights from Geo-Data, the present invention further relates to improvements in sustainability and environmental developments: together we create a safe and livable world.

### FIELD

The present disclosure relates to a computer-implemented method and related apparatuses for identifying and classifying a magnetic anomaly, for example from geophysical survey data. Unlocking insights from Geo-Data, the present invention further relates to improvements in sustainability and environmental developments: together we create a safe and livable world.

### BACKGROUND

Geophysical surveys are carried out to gather information about the characteristics of the ground—both at the surface, and under the surface. The region under the surface is typically referred to as subsurface. Geophysical surveys are a crucial tool in site characterisation for infrastructure projects, foundation calculations, pipeline inspection, unexploded ordinances (UXO) detection, and so on. In contrast to geotechnical surveys, geophysical surveys are non-invasive.

A known type of geophysical survey is a magnetic survey. Magnetic surveying is used to measure the magnetic behaviour of the ground and subsurface. In short, magnetic surveys aim to measure the variations in the two-dimensional magnetic field caused by subsurface magnetic materials. Magnetic surveying is especially useful for detecting objects within the seabed and/or its subsurface. For example, magnetic surveying is a powerful tool in the detection of UXOs on, within and/or under the seabed. For completeness, UXOs typically contain magnetic materials.

Usefully, magnetic surveying of the seabed can be done in a non-invasive manner. This mitigates the need for physical subsurface testing, which is expensive, has an inherent risk, and takes a large amount of time. Known approaches to magnetic detection of the seabed include the use of standard marine magnetometers and the use of atomic magnetometers, both of which are total field magnetometers measuring the total ambient magnetic field. Magnetometers of these kinds are typically towed over the seabed behind a survey vessel.

Once a magnetic survey has been carried out, the data must be processed and interpreted. A known approach to interpreting magnetic survey data is to do so manually. However, survey regions can be very large and, though fairly accurate, manual interpretation is time consuming and costly. Manual interpretation is therefore too slow and expensive to be suitable for large scale building projects, such as offshore wind farms. It is therefore desirable to automate as far as possible the processing and interpretation of the data to reduce the human burden, speed up the surveying process and avoid human errors.

A known approach to automated interpreting of magnetic data is to use the Blakely test. This is an automated approach to ‘peak-picking’ based on a technique by Blakely (1986). In short, the test can be used to identify peaks in the data, which are representative of magnetic anomalies in the seabed or its subsurface. Such magnetic anomalies can be representative of UXOs, for example. A disadvantage of the Blakely test is that it exhibits low levels of accuracy, meaning that a significant amount of manual interpretation is still required. Manual interpretation is undesirable for the reasons mentioned above. A key reason for the low accuracy of the Blakely test is that it works on analytical signals derived from the magnetic survey data. This derivative-based data is (1) more susceptible to errors related to combining data from different survey vessel sail lines; and (2) does not yield good positioning of a significant portion of magnetic anomalies—a key output of the processing and interpreting of magnetic survey data.

Another disadvantage of the Blakely test is that although it can be used to identify peaks in the magnetic survey data and the positions of those peaks (albeit with poor levels of accuracy), it is highly desirable to know still more about the magnetic anomalies identified, particularly in an automated way.

As can be seen, existing approaches to processing and interpreting magnetic survey data suffer from significant drawbacks. It would be advantageous to provide a method and apparatus which address one or more of these problems, in isolation or in combination.

### SUMMARY

This overview introduces concepts that are described in more detail in the detailed description. It should not be used to identify essential features of the claimed subject matter, nor to limit the scope of the claimed subject matter.

According to a first aspect, there is provided a computer-implemented method for identifying and classifying a magnetic anomaly, comprising: receiving data indicative of the magnetic profile of at least a portion of a target area; identifying a first extremum in the received data, wherein the first extremum is representative of a magnetic anomaly in the target area; identifying a second extremum in the received data, wherein the second extremum is representative of the same magnetic anomaly or a further magnetic anomaly in the target area and has an opposite polarity to the first extremum; and classifying the first extremum as a monopole or the first and second extrema as belonging to a first dipole. In the context of the present invention providing a computer-implemented method for identifying and classifying a magnetic anomaly, the monopole and the dipole are respectively a magnetic monopole and a magnetic dipole. In the context of the present invention, the magnetic anomaly is caused by a physical object. The physical object that causes the anomaly has a shape and size defining the magnetic anomaly around said physical object. The shape of the anomaly can be approximated as a magnetic monopole or magnetic dipole shape. The method according to the present invention allows the identifying and classifying of a magnetic anomaly at its exact location as a magnetic monopole or magnetic dipole.

Advantageously, an automated method for identifying and classifying magnetic anomalies from geophysical survey data, for example, is thus provided which does not suffer from the same disadvantages as the described existing approaches. For example, it is faster than existing approaches; less burdensome because it is a fully automated approach to both identifying and classifying magnetic anomalies; and it outputs more information about an identified anomaly than existing approaches. Importantly, it is also a more accurate approach than those making use of the Blakely test because it does not rely on the analytical signals as an input.

The classification of extrema into monopoles or dipoles is particular technically advantageous because it allows the user to (1) determine whether the first and second extrema are representative of the same or different magnetic anomalies; and (2) understand the real world orientation of magnetic anomalies in the target area. For example, if an extremum is classified as a monopole, then the magnetic anomaly it represents is likely to be substantially vertically orientated in the ground. In comparison, if two extrema are classified as belonging to a same dipole, then the magnetic anomaly they represent is likely to be substantially horizontally orientated in the ground. Such information is extremely useful when planning building projects, such as offshore windfarms.

The method may further comprise determining whether the first and second extrema are representative of the same or different magnetic anomalies. The step of determining may comprise: if the first extremum is classified as a monopole, determining that the first and second extrema are representative of different magnetic anomalies; and if the first and second extrema are classified as belonging to the first dipole, determining that the first and second extrema are representative of the same magnetic anomaly.

The step of classifying may comprise: determining the affinity between the first and second extrema; if the affinity is below a threshold value, classifying the first extremum as the monopole; and if the affinity is equal to or above the threshold value, classifying the first and second extrema as belonging to the first dipole.

The received data may be, or may be derived from, geophysical survey data of the target area. The received data may be a processed version of the geophysical survey data. Processing techniques applied to the geophysical survey data to generate the received data may include smoothing and/or filtration of trends. For example, the received data may be residual data. Advantageously, such data has good levels of accuracy and is robust. For example, as previously described, it is not as susceptible to errors as the analytical signals used in existing approaches.

The geophysical survey may be a magnetic geophysical survey. The magnetic geophysical survey may be carried out using one or more magnetometers. The geophysical survey data may be magnetic flux data. The received data may be one dimensional (1 D) or two dimensional (2D).

The method may be a method for identifying and classifying a magnetic anomaly from geophysical survey data of the target area.

The magnetic anomaly and/or the further magnetic anomaly may be an unexploded ordnance (UXO). The target area may be an area of seabed and/or its subsurface.

Optionally, the first extremum is a maximum and the second extremum is a minimum. Alternatively, the first extremum may be a minimum and the second extremum may be a maximum. That is, the first extremum may be a positive or a negative extremum (i.e. it may have positive or negative polarity/amplitude sign); and the second extremum may be the other of a positive or a negative extremum (i.e. it may have the other of positive or negative polarity/amplitude sign).

The method may include, prior to the steps of identifying the first and second extrema, smoothing the received data. The received data may be smoothed using Gaussian smoothing. Alternatively or additionally, the step of smoothing the received data may comprise interpolating and/or extrapolating between data points in the received data. Advantageously, this provides a more complete representation of the target area in a time efficient way and without requiring additional survey equipment (additional equipment can be costly and difficult to manage in practice—for example, a single survey vessel can only in practice tow a finite number of sensors without sensors becoming tangled).

Identifying the first and/or the second extremum may comprise determining the second derivative of the received data (or the smoothed received data), and optionally identifying the first and/or the second extremum from the second derivative data. This is an accurate approach which leads to low numbers of false positives.

The method may additionally comprise carrying out a filtering step before the step of classifying the first extremum as a monopole or the first and second extrema as belonging to a same first dipole.

The method may additionally comprise: identifying a third extremum in the received data having the same polarity as the first extremum; and, if the distance between the first and third extrema is below a search radius, filtering out the one of the first and third extrema having the smaller amplitude. For example, the step of filtering may comprise filtering out the third extremum if the distance between the first and third extrema is below a search radius and the amplitude of the third extremum is less than the amplitude of the first extremum. The search radius may be determined based on the amplitude of the first and/or third extremum. The third extremum may be representative of the same magnetic anomaly as the first extremum.

Advantageously, the filtering out of extrema in this way removes duplications. That is, it avoids there being two nearby extrema representing the same magnetic anomaly. It thus also reduces the likelihood that ultimately there is more than one monopole or dipole associated with a same magnetic anomaly. Such duplications are typically unwanted as they could lead to unnecessary additional computer processing burden and, in some cases, false positives.

Optionally, as noted above, the filtering step is carried out before the step of classifying the first extremum as a monopole or the first and second extrema as belonging to a same first dipole. Advantageously, by carrying the filtering step out early on in the method, the overall computer processing burden is reduced because subsequent steps, such as the determining step, need not be carried out with respect to duplicative extrema.

The affinity between the first and second extrema may be based on at least one characteristic of the first and second extrema. The at least one characteristic may be the distance between the first and second extrema and/or the amplitude difference between the first and second extrema. For example, the affinity between the first and second extrema may be based on the distance between the first and second extrema and the amplitude difference between the first and second extrema. The threshold value may be substantially zero. For example, the threshold value may be exactly zero.

Advantageously, an approach for determining whether or not extrema should be linked and classified as belonging to a same dipole is thus provided. As previously discussed, the classification of two extrema as belonging to a same dipole allows the user to understand the real world orientation of the related magnetic anomaly in the target area. Furthermore, the described approach for determining whether or not extrema should be linked is both accurate and suitable for automation. For example, it is not overly computationally burdensome.

The method may comprise an amplitude filtering step. The amplitude filtering step may comprise receiving a user input indicative of a threshold amplitude. The threshold amplitude may be around 5 nano Tesla (nT). The amplitude filtering step may be carried out after the step of classifying the first extremum as a monopole or the first and second extrema as belonging to a first dipole. The amplitude filtering step may comprise: if the first extremum is classified as a monopole, filtering out the monopole if the amplitude of the monopole is less than a or the threshold amplitude; or, if the first and second extrema are classified as belonging to a first dipole, filtering out the first dipole if the peak-to-peak amplitude of the first dipole is less than a or the threshold amplitude.

Usefully, by filtering the extrema based on their amplitude, it is possible to control the sensitivity of the magnetic anomaly identification and classification. This helps to avoid false positives and filter out inconsequential magnetic anomalies.

The method may further comprise identifying a second dipole (for example, in substantially the same way as for the first dipole), wherein one of the extrema in the second dipole is the first or second extremum. The method may further comprise disconnecting the extrema in the one of the first and second dipole having the lowest affinity between its extrema. That is, the extrema in the second dipole may be disconnected if the affinity between them is less than the affinity between the extrema in the first dipole, and vice versa.

Put another way, the method may additionally comprise identifying (for example, in substantially the same way as for the first extremum) a fourth extremum in the received data having an opposite polarity to one of the first and second extrema; and determining (for example, in substantially the same way as for the first extremum) that the fourth extremum is representative of the same magnetic anomaly as the first or second extrema. The determining step may comprise classifying that the fourth extremum and the one of the first or second extrema belong to a or the same second dipole. The method may further comprise reclassifying the fourth extremum as a further monopole if the affinity between the fourth extremum and the one of the first or second extrema is less than the affinity between the first and second extrema. Again, that is, the extrema in the second dipole may be disconnected if the affinity between them is less than the affinity between the affinity in the first dipole. In that case, the fourth extrema may be reclassified as a further monopole.

Advantageously, this avoids there may being multiple, overlapping dipoles connected to the same magnetic anomaly. This is generally not desirable as it leads to false positives and can mask the presence of additional magnetic anomalies. It is therefore useful to identify when dipoles are overlapping and reclassify them. Reclassifying the redundant extremum as a monopole indicates to the user that an additional magnetic anomaly has been identified. The step of disconnecting overlapping dipoles is thus a powerful tool for improving the accuracy of the method.

The method may further comprise reclassifying extrema in a same dipole as monopoles if the ratio between the amplitudes of the extrema is greater than or equal to a threshold skew value. The threshold skew value may be around 6. For example: it may be 5.5, 6 or 6.5.

Advantageously, this reclassifying step increases the accuracy of the monopole/dipole classifications, and thus translates to more accurate information about the magnetic anomalies and their orientations in the target area (and real world).

The method may further comprise determining one or more attributes for the or each monopole and/or dipole. The attributes may comprise one or more of amplitude (for example, maximum amplitude), wavelength (that is, size) and position. For the first dipole, the attributes may additionally or alternatively comprise the peak-to-peak distance. The position may be a location expressed, for example, using coordinates.

Advantageously, because the method operates on data derived from geophysical survey data, such as residual magnetic survey data, the attributes determined are more accurate than known approaches. This is especially the case for the positioning of the monopole or the dipole, which is particularly helpful in any subsequent geophysical exploration, geotechnical surveying, or building projects, say.

According to another aspect, there is provided a computer program product comprising instructions which, when the program is executed by a computer, cause the computer to carry out the method of the first aspect.

According to a further aspect, there is provided apparatus configured to perform the method of the first aspect.

According to yet another aspect, there is provided computer-readable medium comprising instructions which, when executed by a computer, cause the computer to carry out the method of the first aspect.

### BRIEF DESCRIPTION OF THE FIGURES

Illustrative implementations of the present disclosure will now be described, by way of example only, with reference to the drawings. In the drawings:

FIG. 1 is a schematic and simplified representation of an offshore geophysical survey site;

FIG. 2 is a flow chart showing a method of identifying and classifying a magnetic anomaly;

FIG. 3 is a flow chart showing, in more detail, a method of classifying a magnetic anomaly;

FIG. 4A is an example mapping of a dipole as identified using the method of FIG. 2;

FIG. 4B is an example mapping of a monopole as identified using the method of FIG. 2;

FIG. 5 is a graph showing a relationship between amplitude and distance which can be used in the method of FIG. 2;

FIG. 6 is a graph showing a relationship between amplitude, distance and dipole affinity which can be used in the method of FIG. 3; and

FIG. 7 is a schematic and simplified representation of a computer apparatus which can be used to perform the method of FIG. 2.

Throughout the description and the drawings, like reference numerals refer to like features.

### DETAILED DESCRIPTION

### Introduction

A computer-implemented method and related apparatuses for identifying and classifying a magnetic anomaly, for example from geophysical survey data, will now be described. In short, the method involves receiving geophysical survey data—such as magnetometer survey data—typically in processed form; identifying extrema in the data; and classifying the extrema into monopoles and dipoles. Because the extrema are representative of real world magnetic anomalies, classification of the extrema as belonging to monopoles or dipoles tells us in turn something about the orientation of the magnetic anomalies in the real world. This is extremely helpful in the planning of building projects, for example. Another key advantage of the described method is that, compared to current approaches, it can reduce the time taken to interpret magnetic profile data by around 75%. The accuracy of the method has also been found experimentally to be good: around 95% accurate classification of extrema as belonging to monopole or dipoles.

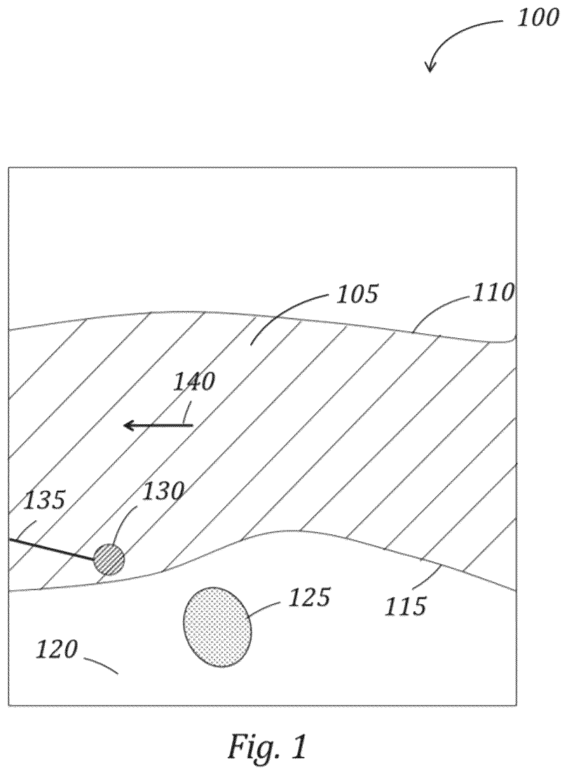

FIG. 1 shows a schematic and simplified representation of an offshore geophysical survey site 100. The site 100 includes sea 105, surface of the sea 110, seabed 115 and subsurface of the seabed 120. Buried beneath the seabed 115, and thus in the seabed subsurface 120, is a magnetic anomaly 125. In this disclosure, a magnetic anomaly is an object which causes a variation in the magnetic field around it. The magnetic anomaly 125 may be a UXO, for example. When a geophysical survey of the site 100 is carried out, a sensor 130 may be towed via a tow cable 135 in the direction of arrow 140 by a vessel (not shown). The site may be an area of interest, for example because it is a potential site for a new construction such as a windfarm. Such an area of interest can be called a target area. In practice, a target area can be large and a single vessel may tow several sensors 130 such that information about a larger region of the seabed 115 and its subsurface 120 can be collected in a single sweep of the vessel over the target area. Throughout this description, reference to “sensor 130” may therefore equally be a reference to “sensors 130”—i.e. more than one sensor 130. The path the vessel takes over the target area is known as its sail line. To collect enough information about the entire target area, the vessel may need to traverse, or sweep over, the target area multiple times, resulting in multiple sail lines. In this example, the sensor 130 is a total field magnetometer and the sensor 130 measures the total ambient magnetic field over the seabed 115 and its subsurface 120. More specifically, the sensor 130 measures the magnetic flux density in nano Tesla (nT). The data collected by the sensor 130 is sent to a remote server for processing and analysis.

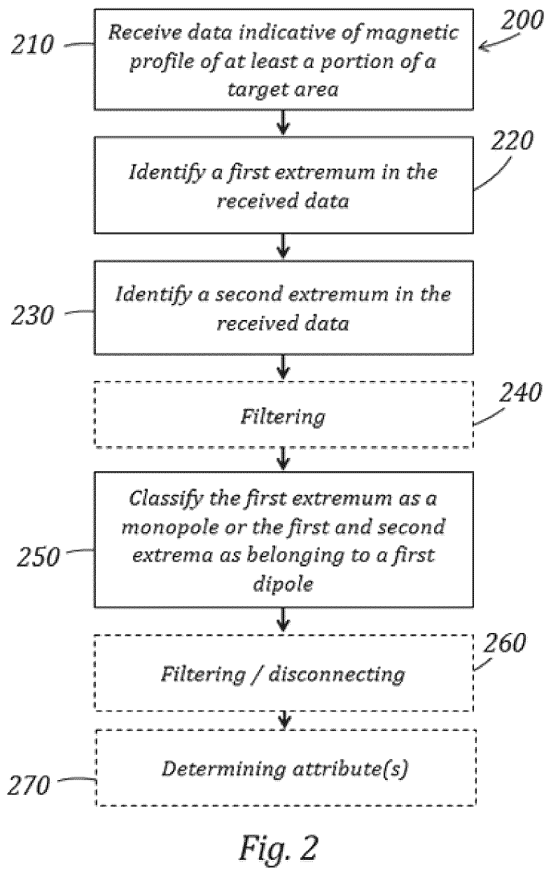

The format of the data collected by the sensor 130 depends upon the sensor type. In any case however, in this example, a multiplexed signal is transmitted via the tow cable 135 to the vessel, and there to acquisition software. In this example, the acquisition software is run on computer apparatus on the vessel, but in other examples, the acquisition software may run elsewhere. The acquisition software processes and saves the signal into at least one format: in this example, the format is comma-separated values (CSV). CSV is well suited to being read by the subsequent processing software, as will be described in connection with FIG. 2. In other examples, the signal may be saved into other formats and indeed multiple formats. Most importantly, the magnetic flux density data collected by the sensor 130 is time stamped. The magnetic flux density data is then combined with position data using the timestamps. An indication of the signal strength can also be recorded. Usefully, the signal strength provides a guide to the reliability of the sensor 130 readings. In this example, the position data is derived from ultra-short baseline acoustic positioning (USBL). USBL is a method of underwater acoustic positioning in which a transceiver is mounted beneath the vessel towing the sensor 130, and a transponder/responder is mounted on or near the sensor 130. This provides accurate position data for the sensor 130 as it travels along the sail line. Alternative approaches for determining the necessary position data are layback (layback is an estimate of the position of the sensor 130 using various assumptions) and from an inertial navigation system (INS).

### Overview of Method

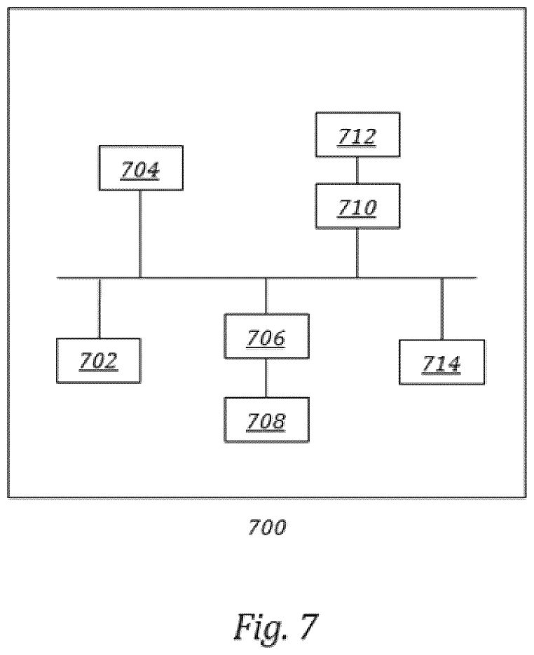

A method 200 for processing and analysing the data collected by the sensor 130 is shown in FIG. 2. More specifically, FIG. 2 shows a method 200 for identifying and classifying a magnetic anomaly. The method 200 is a computer-implemented method. Computer apparatus 700 which can be used to perform the method 200 is described later in reference to FIG. 7.

The method 200 begins at step 210. At step 210, data is received which is indicative of the magnetic profile of at least a portion of a target area. The magnetic profile describes variation of the magnetic field over at least a portion of the target area. In this example, the sensor 130 measures magnetic flux density and so the received data has a unit of nT.

In this example, the received data is not the raw data collected by the sensor 130 (that is, the raw geophysical survey data). Instead, the received data is a processed version of the raw data. Processing of the raw data is described later in this description. In this example, the format of the received data is CSV. In other examples, alternative data formats could be used.

Next, at step 220, a first extremum is identified in the received data. Extrema are the peaks in the data. Because magnetic flux density can be positive or negative, extrema are both the positive (maximum) and the negative (minimum) peaks. Extrema are representative of magnetic anomalies in the target area. A single extremum can be the sole representative of a particular magnetic anomaly. Alternatively, multiple extrema can represent a particular anomaly. This is discussed in more detail below. This identified first extremum is understood to represent a magnetic anomaly in the target area.

Next, at step 230, a second extremum is identified in the received data. The second extremum is understood to represent either the same magnetic anomaly as the first extremum or a different magnetic anomaly in the target area (that is, a further magnetic anomaly). In this example, the second extremum has an opposite polarity (that is, amplitude sign) to the first extremum. For example, the first extremum may be a positive (maximum) peak and the second extremum may be a negative (minimum) peak, or vice versa.

Next, at step 240, a preliminary filtering step may be carried out. This is described in more detail below.

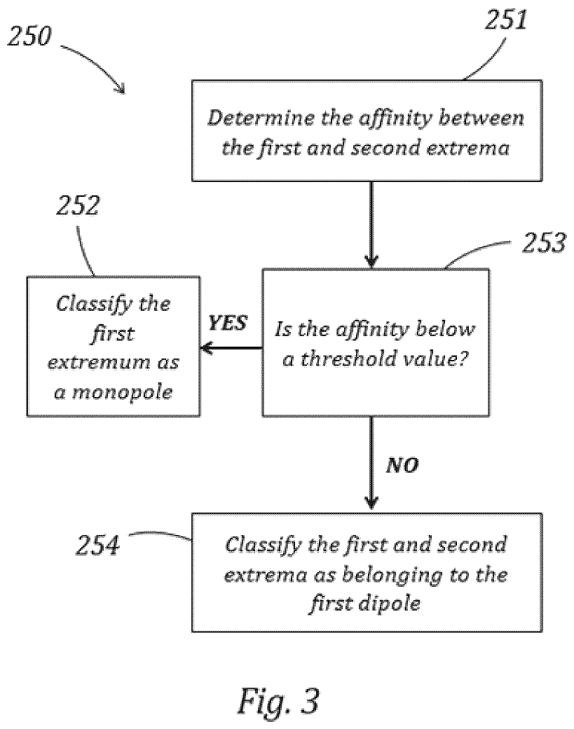

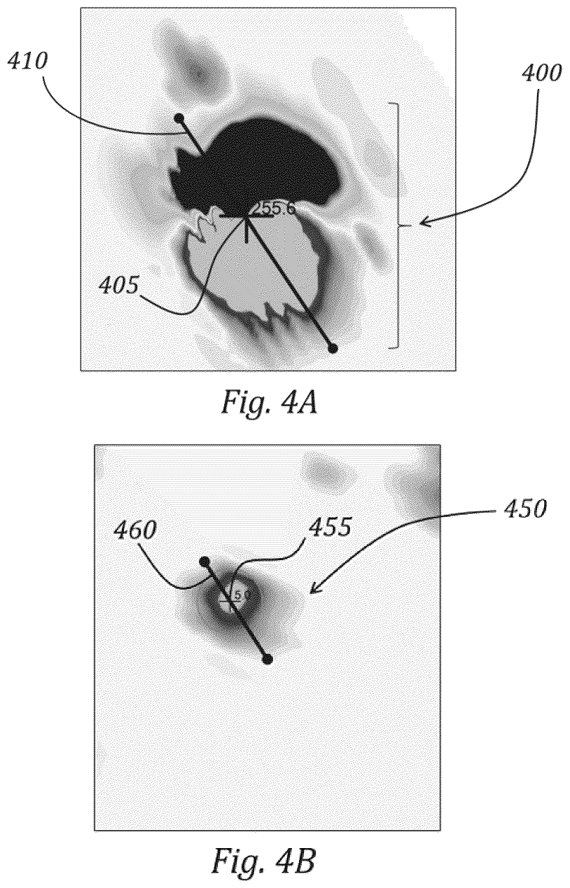

Next, at step 250, the first extremum is classified either as a monopole or as belonging to a same dipole as the second extremum. The method for this is described in more detail below in reference to FIG. 3. For completeness, a monopole is a theoretical single point magnetic pole. An example mapping of a monopole 450 is shown in FIG. 4B. In contrast, a dipole has both positive and negative poles, like a traditional magnet. An example mapping of a dipole 400 is shown in FIG. 4A.

Next, at step 260, a (further) filtering and disconnecting step may be carried out. This is described in more detail below.

Finally, at step 270, attributes of the identified monopole or dipole may be determined. This is described in more detail below. In this example, the determined attributes are amplitude, wavelength and position. For dipoles, the determined attributes also includes the peak-to-peak distance (for the extrema in the dipole).

The steps of the method 200 will now be described in more detail.

### Processing of the Raw Data

The raw data collected by the sensor 130 is typically processed in two ways before the data is received at step 210. First, to extract the trend—for example, ambient noise is filtered out such that only magnetic flux density variation caused by the target area remains. This is called the residual data. Second, smoothing is applied. The raw data is typically processed offshore.

The raw data collected by the sensor 130 is one-dimensional (1 D). This means that it is collected from a single sail line. If however as part of a survey there are multiple, parallel sail lines, then the 1D data corresponding to these sail lines can be gridded to generate gridded two-dimensional (2D) data. This is particularly advantageous when data has been acquired along parallel sail lines which have limited spacing between them. And although any magnetometer data can be gridded, for these dense types of surveys (that is, for surveys where the sail lines are close together), it is especially advantageous to grid the 1D data of the sail lines to generate gridded 2D data. The data received at step 210 may be 1 D or 2D data.

Both 1D and 2D data have a smoothing technique applied, such as Gaussian smoothing. Gaussian smoothing is a method of blurring using a Gaussian function in order to reduce noise and detail in the data set. Gaussian smoothing requires an empirically chosen smoothing distance parameter. In this disclosure, empirically chosen means chosen through observation or experience, rather than purely through theory or logic. The smoothing distance parameter used may have a value of around 1.2 m, for example. Other values for the smoothing parameter may also be used, such as around 1 m, exactly 1.2 m, or around 1.4 m. For 2D data, additional smoothing can also be applied in the form of interpolating and/or extrapolating between data points such that areas of the target area not covered by the sensor 130, for example areas between sail lines, can be ‘filled in’ based on the data collected for the areas either side.

For 2D data, additional processing can also be applied in the form of amplifying the data for its ‘peakyness’. This makes the extrema in the data easier to identify. This is done using a Laplace filter based on approximate second derivates. The effect of the amplification step is normalized by a logistic function. Normalization using an adaptation of the logistic function is a well-known technique and, in this example, follows Equation 1.

$${X}_{n o r m} [ x ] = ( \frac{2}{1 + {e}^{( \frac{- x}{L} )}} - 1 ) * K \qquad Equation 1$$

### Where:

x=Input
L=Constant
K=Constant
Xₙₒᵣₘ=Normalized output
   In one example, the values used for the constants are:
L=1
K=1

### Preliminary Filtering the Extrema

At step 240 of the method 200, a preliminary filtering step may be carried out. The aim of this step is to identify nearby extrema having the same polarity (that is, amplitude sign) and filter out the one with the smaller amplitude. That is, the one with the smaller absolute amplitude. This is to avoid duplications, i.e. multiple (same polarity) extrema connected to the same magnetic anomaly. Such duplications might happen if a magnetic anomaly is very long, for example.

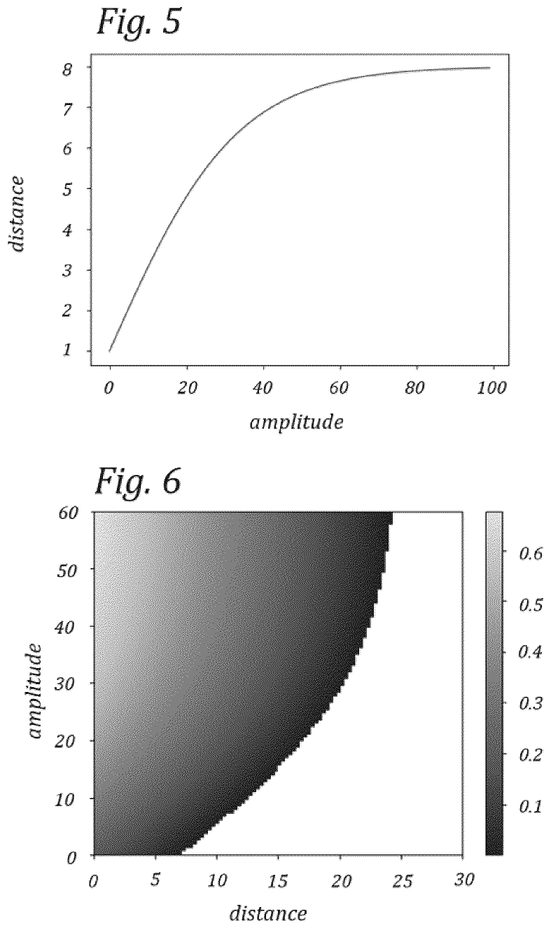

The steps of the preliminary filtering step will now be described. First, a search radius is defined for a given extremum—for example, the first extremum. The search radius depends on the (absolute) amplitude of the first extremum. The graph shown in FIG. 5 can be used to determine the search radius. FIG. 5 is a graph showing a relationship between amplitude (x-axis) and distance (y-axis). The relationship is a curved one with a steep incline at low amplitudes, before flattening out at higher amplitudes. The relationship (and curve) is empirically chosen and follows Equation 2, which is based on the already mentioned logistic function (see Equation 1).

$${R}_{s e a r c h} = ( \frac{2}{1 + e ( \frac{- \vert A \vert}{{R}_{scalar}} )} - 1 ) * ( {R}_{max} - {R}_{min} ) + {R}_{min} \qquad Equation 2$$

### Where:

A=[nT] Amplitude
R_{search}=[m] Search radius
R_{scalar}=[m] Constant
Rₘₐₓ=[m] Constant, maximum search radius
Rₘᵢₙ=[m] Constant, minimum search radius
   In one example, the values used for the constants are:
R_{scalar}=8 m
Rₘₐₓ=8 m
Rₘᵢₙ=1 m

In practice, the absolute amplitude of the first extremum can be compared to the curve shown in FIG. 5 and the distance value for that amplitude value read off. The distance value is the search radius. A search for same polarity (same amplitude sign) extrema falling within that search radius is then performed. If an extremum—for example, a third extremum—is found, then the amplitudes of the first extremum and the third extremum are compared and the extremum with the smaller amplitude is filtered out.

### Finding Natural Neighbours

As already mentioned, at step 250 of the method 200, the first extremum is classified either as a monopole or as belonging to a same dipole as the second extremum. In short, to distinguish between monopoles and dipoles, the method attempts to find a ‘natural neighbour’ of opposite polarity for each extrema. If a natural neighbour cannot be found, then the extrema is classified as a monopole. The method performed at step 250 will now be described in detail in reference to FIG. 3 which provides an overview of the sub steps involved.

At sub step 251, the affinity between the first and second extrema is determined. The affinity is determined based on the distance between the extrema and the difference between their amplitudes. First, the distance and amplitude difference are each normalized using a respective logistic function (already mentioned), such as the functions shown in Equations 3 and 4 below. The two equations are the same but use different empirically found constants.

The amplitude difference is normalized using Equation 3.

$${A}_{norm} = ( \frac{2}{1 + {e}^{( \frac{- A}{{A}_{s c alar}} )}} - 1 ) * {A}_{s e n s i t i v i t y} \qquad Equation 3$$

### Where:

Aₙₒᵣₘ=[n T] Normalized amplitude
A=[nT] Amplitude difference between negative and positive extrema
A_{scalar}=Constant
A_{sensitivity}=Constant defining the sensitivity to amplitude
   In one example, the values used for the constants are:
A_{scalar}=16
A_{sensitivity}=0.5

The distance between the first and second extrema is normalized using Equation 4.

$${D}_{n o r m} = ( 1 - \frac{D}{{D}_{s c a l a r}} ) * {D}_{s e n s i t i v i t y} \qquad Equation 4$$

### Where:

Dₙₒᵣₘ=[m] Normalized distance
D=[m] Distance between negative and positive extrema
D_{scalar}=Constant
D_{sensitivity}=Constant defining the sensitivity to distance
   In one example, the values used for the constants are:
D_{scalar}=20 m
D_{sensitivity}=0.5

The results of Equations 3 and 4 are input to Equation 5 to determine the affinity between the two extrema.

Affinity=Aₙₒᵣₘ+Dₙₒᵣₘ+Dipole_sensitivity Equation 5

### Where:

Dipole_sensitivity=Constant defining the sensitivity
   In one example, the value used for the constant is:
Dipole_sensitivity=−0.3

FIG. 6 shows in graphical form the output of Equation 5. Specifically, the normalized amplitude difference is shown on the y-axis. The distance between the extrema is shown on the x-axis. The affinity between the extrema is shown on the plot using a greyscale, where light grey is high, dark grey is low, and white space is zero—that is, no—affinity.

The output of sub step 251 is therefore a value of affinity. At sub step 252 the affinity is compared to a threshold value. In this example, the threshold value is zero. If the affinity is below the threshold (or, in this example, equal to the threshold), then the method moves to sub step 252 and the first extremum is classified as a monopole. Similarly, the second extremum may also be classified as a monopole. Conversely, if the affinity is above the threshold, then the method moves to sub step 254 and the first and second extrema are classified as belonging to the same dipole (i.e. the first dipole of method 200).

If there a multiple candidates for being the nearest neighbour for a given extremum, optionally the method may include determining the affinity for the given extremum with each of the candidate neighbours and then comparing the determined affinity values. The candidate with which the extremum has the highest affinity value is chosen as the nearest neighbour and the extremum and that candidate classified as belonging to a same dipole.

Further Filtering and/or Disconnecting Dipoles

As already mentioned, at step 260, a (further) filtering and/or disconnecting step may be carried out. This will now be described in more detail. Step 260 can include up to three distinct operations. Each operation is independent of the other three and any number of the operations may be performed. The three operations will now be described.

The aim of this operation is to avoid there being multiple overlapping dipoles connected to the same monopole. This operation involves first identifying that a particular extremum (such as the first or second extremum) is classified as being in two dipoles (for example, the first dipole and a second dipole, where the second dipole also comprises a fourth extremum). In practice, this is done by searching for extrema that occur multiple times. The next step is to compare the affinity values for the dipoles. The affinity for each dipole is determined in the same way as previously described in reference to step 250. The dipole having the lower affinity value is broken up. This means its extrema are disconnected and the extremum not in the dipole with the higher affinity value (i.e. the now redundant extrema, such as the fourth extremum) is reclassified as a monopole.

The aim of this operation is to apply a level of sensitivity to the method 200. In this operation, a threshold amplitude value is chosen by, for example, a user. An example threshold amplitude value is around 5 nT. For example, it may be 4.5, 5 or 5.5 nT. The threshold amplitude value may be input via a user device 712 of computer system 700. Computer system 700 is described in more detail in reference to FIG. 7. As shown in FIG. 2, this operation is carried out after the step of classifying a particular extremum (such as the first extremum) as a monopole or as belonging to a dipole (such as the first dipole). If the extremum is identified as a monopole, the operation involves comparing the (peak) amplitude of the monopole to the threshold amplitude value. (That is, the peak amplitude of the monopole measured from 0 nT). If the amplitude of the monopole is less than the threshold amplitude value, then the monopole is filtered out. Alternatively, if the extremum is identified as belonging to a dipole, the operation involves comparing the peak-to-peak amplitude of the dipole to the threshold amplitude value. If the peak-to-peak amplitude of the dipole is less than the threshold amplitude value, then the dipole is filtered out.

The advantage of filtering based on amplitude after classification of a particular extremum as a monopole or dipole is that, before classification, it is not possible to measure peak-to-peak amplitude values.

The aim of this operation is to identify dipoles where the extrema have very different absolute amplitude values and break up these dipoles. This is to improve the accuracy of the classification step. In more detail, the amplitudes of extrema in a same dipole (for example, the amplitudes of the first and second extremum in the first dipole) are compared and if the ratio between them (the ratio being the amplitude of one divided by the other) is greater than or equal to a threshold value then the dipole is broken up. This means the extrema in the dipole are disconnected and reclassified as monopoles. The threshold value is referred to in this disclosure as the threshold skew value. The threshold skew value is an empirically chosen value. In one example, the threshold skew value is around 6. For example, 5.5, 6 or 6.5.

### Attributes

As already mentioned, at step 270, attributes of the magnetic anomaly associated with the identified monopole or dipole may be determined. This step will now be described in more detail, with particular reference to FIGS. 4A and 4B. The attributes typically determined are maximum amplitude, wavelength (that is, size) and position. For dipoles, the peak-to-peak distance is also determined. Each of these will now be discussed in turn.

The aim here is to determine the geographical or map position of the magnetic anomaly. For completeness, the geographical position is the position in terms of latitude and longitude. Whereas the map position is the position in terms of XY coordinates.

For a monopole, this is the position of the associated extremum. As shown in FIG. 4B, which is an example mapping of a monopole 450 identified using the method 200, the monopole 450 is determined as having position 455. The position 455 is the position of the extremum associated with this monopole, which is known from the data received at step 210 of the method 200. In other words, as discussed previously, location information is included with the received data.

For a dipole, the position of the magnetic anomaly is an estimate of the most likely actual position. As shown in FIG. 4A, the dipole 400 is determined as having position 405. The position 405 is determined using zero crossing. This means identifying the position where the amplitude between the two extrema in the dipole falls to zero. The zero crossing point can be found on the line 410 between the extrema and is the point on this line where the amplitude is zero. Other approaches for estimating the most likely actual position of a dipole involve: identifying the middle of the dipole—the middle is the point on the line 410 which is halfway between the two extrema (in terms of distance along the line); and/or identifying the point of maximum amplitude inflection between the two extrema in the dipole. In particular, one or both of the latter two approaches (middle point and maximum amplitude inflection) can be used if, for example, the position 405 cannot be determined using zero crossing. Reasons it may not be possible to identify the position 405 using zero crossing are if there are multiple zero crossing points and/or if there are gaps in the data.

The aim here is to determine the maximum amplitude for the magnetic anomaly. When an extremum is identified in method 200 (at step 220 or 230), the amplitude of the extremum (i.e. the identified peak) may not actually be the maximum magnetic flux density value for the associated magnetic anomaly (i.e. the largest peak). A discrepancy here can arise in the processing of the raw sensor 130 data, for example, particularly as a result of any smoothing applied. This is because although the processing results in good positioning of the magnetic anomalies via the positioning of the extremum, the maximum amplitude value of the magnetic anomaly may not coincide with the position of the extremum. To find the maximum amplitude for a magnetic anomaly, a maximum filter is applied. In practice, this means carrying out a search for a local maximum around the position(s) of the extremum or extrema. This technique is applicable for all extrema, regardless of whether they are (subsequently or presently) classified as being monopoles or belonging in dipoles.

The aim here is to determine the wavelength for the magnetic anomaly. The wavelength can be used to infer information about the magnetic anomaly, such as its depth in the subsurface.

The way in which the wavelength is determined is different for monopoles and dipoles, as will now be described.

For monopoles, numerous lines 460 are drawn which pass through the identified position of the magnetic anomaly 455 (and thus the position of the extremum) from zero to zero. That is, from zero to zero magnetic flux density. The lines may be drawn theoretically or in practice (though electronically, i.e. using computer system 700. The distances of the lines are measured and the average taken. This value is taken as the real world size of the magnetic anomaly.

For dipoles, a line 410 is drawn from zero to zero through the two extrema of the dipole. As before, zero to zero means from zero to zero magnetic flux density. Similarly, the lines may be drawn theoretically or in practice (though electronically). The distance of the line is measured. This value is taken as the real world size of the magnetic anomaly.

Particularly when 2D data has been used, the edges of the monopole under inspection may not be clear. This is especially the case when there are magnetic anomalies close to each other. This can make it difficult to measure the size of the monopole. In this case, and particularly when 2D data has been used, a watershed algorithm can be used. This defines the boundary of the monopole and thus enables the size of the monopole to be measured.

In other examples, such a watershed algorithm could alternatively or additionally be used to measure the size of a dipole.

### Implementation

An advantage of method 200 is that it can be used within existing, commercially available subsequent processing software packages, such as existing commercially available software packages used for magnetometer processing. Python is a suitable language for writing the program to implement the method 200. Other suitable languages are C, C++ and/or .NET. The implementation includes the required scripts needed to run the implementation from within the commercially available subsequent processing software processing, using its Application Programming Interface (API).

### Computer System

Turning finally to FIG. 7, FIG. 7 shows a schematic and simplified representation of a computer apparatus 700 which can be used to perform the methods described herein, either alone, in combination with other computer apparatuses or as part of a “cloud” computing arrangement.

The computer apparatus 700 comprises various data processing resources such as a processor 702 (in particular a hardware processor) coupled to a central bus structure. Also connected to the bus structure are further data processing resources such as memory 704. A display adapter 706 connects a display device 708 to the bus structure. One or more user-input device adapters 710 connect a user-input device 712, such as a keyboard and/or a mouse to the bus structure. One or more communications adapters 714 are also connected to the bus structure to provide connections to other computer systems 700 and other networks.

In operation, the processor 702 of computer system 700 executes a computer program comprising computer-executable instructions that may be stored in memory 704. When executed, the computer-executable instructions may cause the computer system 700 to perform one or more of the methods described herein. The results of the processing performed may be displayed to a user via the display adapter 706 and display device 708. User inputs for controlling the operation of the computer system 700 may be received via the user-input device adapters 710 from the user-input devices 712.

It will be apparent that some features of computer system 700 shown in FIG. 5 may be absent in certain cases. For example, one or more of the plurality of computer apparatuses 700 may have no need for display adapter 706 or display device 708. This may be the case, for example, for particular server-side computer apparatuses 700 which are used only for their processing capabilities and do not need to display information to users. Similarly, user input device adapter 710 and user input device 712 may not be required. In its simplest form, computer apparatus 700 comprises processor 702 and memory 704.

### Variations

The above detailed description describes a variety of exemplary arrangements of and methods of using a control mechanism. However, the described arrangements and methods are merely exemplary, and it will be appreciated by a person skilled in the art that various modifications can be made without departing from the scope of the appended claims. Some of these modifications have already been described and others will now be briefly described, however this list of modifications is not to be considered as exhaustive, and other modifications will be apparent to a person skilled in the art.

As noted above, in this example, the sensor 130 is a total field magnetometer and the sensor 130 measures the total ambient magnetic field over the seabed 115 and its subsurface 120.

### CONCLUSION

While various specific combinations of components and method steps have been described, these are merely examples. Components and method steps may be combined in any suitable arrangement or combination. Components and method steps may also be omitted to leave any suitable combination of components or method steps.

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the disclosure. It will also be apparent that there are many variations that have not been described, but that fall within the scope of the appended claims.

1. A computer-implemented method for identifying and classifying a magnetic anomaly, the method comprising:
receiving data indicative of a magnetic profile of at least a portion of a target area;
identifying a first extremum in the received data, wherein the first extremum is representative of a magnetic anomaly in the target area;
identifying a second extremum in the received data, wherein the second extremum is representative of a same magnetic anomaly or a further magnetic anomaly in the target area and has an opposite polarity to the first extremum; and
classifying the first extremum as a monopole or the first extremum and the second extremum as belonging to a first dipole.

2. The computer-implemented method of claim 1, wherein the step of further comprising:
determining an affinity between the first extremum and the second extremum;
when the affinity is below a threshold value, classifying the first extremum as a monopole; and
when the affinity is above the threshold value, classifying the first extremum and the second extremum as belonging to the first dipole.

3. The computer-implemented method of claim 2, wherein the affinity between the first extremum and the second extremum is based on at least one characteristic of the first extremum and the second extremum.

4. The computer-implemented method of claim 3, wherein the at least one characteristic is a distance between the first extremum and the second extremum and/or an amplitude difference between the first extremum and the second extremum.

5. The computer-implemented method of claim 1, further comprising:
identifying a third extremum in the received data having a same polarity as the first extremum; and
when a distance between the first extremum and the third extremum is below a search radius, filtering out the one of the first extremum and the third extremum having a smaller amplitude.

6. The computer-implemented method of claim 5, wherein the search radius is determined based on the amplitude of the first extremum and/or the third extremum.

7. The computer-implemented method of claim 5, wherein the filtering is carried out before classifying the first extremum.

8. The computer-implemented method of claim 1, further comprising:
when the first extremum is classified as a monopole, filtering out the monopole if an amplitude of the monopole is less than a threshold amplitude; or
when the first extremum and the second extremum are classified as belonging to a first dipole, filtering out the first dipole when a peak-to-peak amplitude of the first dipole is less than the threshold amplitude.

9. The computer-implemented method of claim 1, further comprising:
identifying a second dipole, wherein one extremum in the second dipole is the first extremum or the second extremum; and
disconnecting the extremum in the one of the first dipole and the second dipole having a lowest affinity between its extrema.

10. The computer-implemented method of claim 1, further comprising:
reclassifying extremum in a same dipole as monopoles when a ratio between amplitudes of the extremum is greater than or equal to a threshold value.

11. The computer-implemented method of claim 1, further comprising:
determining one or more attributes for each monopole and/or dipole.

12. The computer-implemented method of claim 11, wherein the one or more attributes comprise one or more of amplitude, wavelength and position.

13. The computer-implemented method of claim 1, wherein the further magnetic anomaly is an unexploded ordnance ‘UXO’.

14. The computer-implemented method of claim 1, wherein the target area is an area of seabed.

15. The computer-implemented method of claim 1, wherein the received data is derived from geophysical survey data of the target area.

16. The computer-implemented method of claim 15, wherein the received data is residual magnetic survey data of the target area.

17.-19. (canceled)

20. A system comprising:
one or more processors;
one or more memories, storing instructions which when executed by at the one or more processors, causes the system to:
receive data indicative of a magnetic profile of at least a portion of a target area;
identify a first extremum in the received data, wherein the first extremum is representative of a magnetic anomaly in the target area;
identify a second extremum in the received data, wherein the second extremum is representative of a same magnetic anomaly or a further magnetic anomaly in the target area and has an opposite polarity to the first extremum; and
classify the first extremum as a monopole or the first extremum and the second extremum as belonging to a first dipole.

21. The system of claim 20, further comprising:
determining an affinity between the first extremum and the second extremum;
when the affinity is below a threshold value, classifying the first extremum as a monopole; and
when the affinity is above the threshold value, classifying the first extremum and the second extremum as belonging to the first dipole.

22. The system of claim 21, wherein the affinity between the first extremum and the second extremum is based on at least one characteristic of the first extremum and the second extremum.

23. The system of claim 22, wherein the at least one characteristic is a distance between the first extremum and the second extremum and/or an amplitude difference between the first extremum and the second extremum.
